(19) United States
(12) Patent Application Publication
(10) Pub. No.: US 2026/0319655 A1
(43) Pub. Date: Oct. 15, 2026

(54) METHOD, TERMINAL, AND MEDIUM FOR SWIPE-BASED USER INTERFACE CHECKOUT

(71) Applicant: Coupang Corp., Seoul (KR)

(72) Inventors: Nae Kyung HUH, Seoul (KR); You Jeong CHANG, Seoul (KR); Na Yeong KIM, Seoul (KR)

(21) Appl. No.: 19/539,503

(22) Filed: Feb. 13, 2026

(30) Foreign Application Priority Data
Apr. 10, 2025 (KR) 10-2025-0046673

(51) Int. Cl. G06F 3/04883; G06F 3/0488; G06F 3/04886

(52) U.S. Cl. CPC G06F 3/04883; G06F 3/0488; G06F 3/04886; G06Q 30/0641

(57) ABSTRACT

A method for controlling a user interface (UI) of a terminal includes displaying a swipe UI for providing a checkout of an item purchase, receiving a swipe input that is generated in response to a user performing a swipe action through the swipe UI, and providing the checkout of the item purchase based on the swipe input being released from a predetermined area of the swipe UI.

### CROSS-REFERENCE TO RELATED APPLICATION(S)

This application claims the benefit of Korean Patent Application No. 10-2025-0046673, filed on Apr. 10, 2025, in the Korean Intellectual Property Office, the disclosure of which is incorporated herein by reference.

### TECHNICAL FIELD

The present disclosure relates to a terminal, a user interface (UI) control method thereof, and a non-transitory computer-readable recording medium including a computer program for performing the method.

### BACKGROUND

With recent technological advancements, consumer behavior is shifting from purchasing large quantities of goods at low prices at supermarkets to purchasing daily necessities in needed quantities at low prices, regardless of whether the purchase is made online or offline. In particular, with the development of e-commerce technology, there has been an increase in the number of cases where items are ordered using web pages or applications.

In an e-commerce environment, streamlining the ordering process may allow customers to complete their purchases quickly and easily. For instance, some platforms may provide a one-click purchase feature, allowing users to complete payments with just a click or touch motion.

In some cases, when implementing the one-click purchase checkout in a mobile application environment, a procedure in which the user completes payment by swiping the terminal screen may be used. In some cases, where the swipe length is long or the swipe end point is ambiguous, it may be difficult for users to proceed with payment smoothly, which may result in a negative impact on the payment completion rate (CTR) or total transaction amount.

### SUMMARY

The present application describes a user interface and a method for controlling the user interface to help facilitate intuitive and quick payment via a swipe action of a user.

The present disclosure describes a terminal for providing a visual feedback or tactile feedback based on a swipe input so that a user intuitively recognizes whether a swipe action for a one-click purchase is completed, a user interface control method thereof, and a non-transitory computer-readable recording medium including a computer program for performing the method.

The present disclosure further describes a terminal for optimizing a user interface associated with a swipe bar so that a user performs a swipe action for a one-click purchase with increased convenience, a user interface control method thereof, and a non-transitory computer-readable recording medium including a computer program for performing the method.

According to one aspect of the subject matter described in this application, a method for controlling a user interface (UI) of a terminal includes displaying a swipe UI for providing a checkout of an item purchase, receiving a swipe input that is generated in response to a user performing a swipe action through the swipe UI, and providing the checkout of the item purchase based on the swipe input being released from a predetermined area of the swipe UI.

Implementations according to this aspect can include one or more of the following features. For example, displaying the swipe UI can include displaying a swipe bar including a swipe handle, where receiving the swipe input can include receiving the swipe input that is generated in response to the user performing a drag action and a release action through the swipe handle along the swipe bar.

In some implementations, receiving the swipe input can include detecting a start of the swipe action based on the user performing an input action on a target area of the swipe UI, the target area including a handle area corresponding to the swipe handle. In some examples, the target area can further include an extended area included in the swipe bar. In some examples, displaying the swipe UI can include displaying the extended area that is not visually distinguished from a remaining area of the swipe bar other than the extended area and the handle area.

In some examples, a size of the extended area can be identical to a size of the predetermined area of the swipe UI. In some examples, a size of the swipe handle can be 20% of a total size of the swipe bar.

In some implementations, the method can further include providing a visual feedback or a tactile feedback based on the swipe input being generated through the swipe handle. In some implementations, the method can further include providing a visual feedback or a tactile feedback based on at least a portion of the swipe handle reaching the predetermined area during the swipe action. In some implementations, the method can further include providing a visual feedback or a tactile feedback based on at least a portion of the swipe handle being released in a state in which at least the portion of the swipe handle is located in the predetermined area during the swipe action.

For example, providing the visual feedback can include changing a color of the swipe handle.

In some implementations, displaying the swipe UI can include displaying the swipe handle at a first end portion of the swipe bar in a first direction, and the predetermined area can be defined at a second end portion of the swipe bar in the first direction. In some examples, the predetermined area can have a predetermined size and corresponds to an area starting from an edge of the second end portion of the swipe bar.

In some examples, providing the checkout of the item purchase can include providing the checkout based on at least a portion of the swipe handle being released in a state in which at least the portion of the swipe handle is located in the predetermined area during the swipe action.

In some examples, the swipe UI can include a UI element configured to distinguish the predetermined area from a remaining area other than the predetermined area of the swipe UI. For example, the UI element can include at least one of a border emphasis, a translucent overlay, or a highlight, corresponding to the predetermined area.

According to another aspect, a non-transitory computer-readable recording medium includes a computer program configured to perform the method described above.

According to another aspect, a terminal includes a processor and a memory storing at least on instruction that, based on being executed by the processor, perform operations. The operations include displaying a swipe user interface (UI) for providing a checkout of an item purchase, receiving a swipe input that is generated in response to a user performing a swipe action through the swipe UI, and providing the checkout of the item purchase based on the swipe input being released from a predetermined area of the swipe UI.

Implementations according to this aspect can include one or more of the following features and the features described above with respect to the method. For example, displaying the swipe UI can include displaying a swipe bar including a swipe handle, and receiving the swipe input can include receiving the swipe input that is generated in response to the user performing a drag action and a release action through the swipe handle along the swipe bar.

In some examples, displaying the swipe UI can include displaying the swipe handle at a first end portion of the swipe bar in a first direction, where the predetermined area can be defined at a second end portion of the swipe bar in the first direction.

In some implementations, it can be possible to have an intuitive purchase recognition by providing an intuitive visual or tactile feedback at the time of completion of a swipe action.

In some implementations, it can be possible to increase a convenience of a swipe action and improve a user experience by optimizing a configuration of a swipe bar and a touch target.

### BRIEF DESCRIPTION OF THE DRAWINGS

FIG. 1 is a diagram illustrating an example of a system including a server and a terminal.

FIG. 2 is a diagram illustrating an example of a terminal.

FIG. 3 is a flowchart illustrating an example method for operating a terminal.

FIG. 4 is a diagram illustrating an example of an item purchase user interface (UI) arranged to be overlaid on an item details page.

FIG. 5 is a diagram illustrating examples of a purchase checkout area.

FIG. 6 is a diagram illustrating examples of a purchase checkout area.

FIG. 7 is a diagram illustrating examples of a purchase checkout area.

### DETAILED DESCRIPTION

In the present disclosure, a “terminal” can be implemented as a computer or a portable terminal capable of accessing a server or another terminal through a network. Here, the computer can include, for example, a laptop computer, a desktop computer, and a notebook equipped with a web browser. The portable terminal can be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, example implementations of the present disclosure will be described in detail with reference to the drawings so that those skilled in the art can easily carry out the present disclosure. The present disclosure can be embodied in many different forms and is not limited to the implementations described herein.

Hereinafter, example implementations of the present disclosure will be described with reference to the drawings.

In describing the example implementations, descriptions of technical contents that are well known in the art to which the present disclosure belongs and are not directly related to the present specification will be omitted. This is to more clearly communicate without obscuring the subject matter of the present specification by omitting unnecessary description.

For the same reason, in the accompanying drawings, some components are exaggerated, omitted, or schematically illustrated. In addition, the size of each component does not fully reflect the actual size. The same or corresponding components in each drawing are given the same reference numerals.

Advantages and features of the present disclosure and methods of achieving them will be apparent from the following example implementations that will be described in more detail with reference to the accompanying drawings. It should be noted, however, that the present disclosure is not limited to the following example implementations, and can be implemented in various forms. Accordingly, the example implementations are provided only to disclose the present disclosure and let those skilled in the art know the category of the present disclosure. In the drawings, implementations of the present disclosure are not limited to the specific examples provided herein and are exaggerated for clarity. The same reference numerals or the same reference designators denote the same elements throughout the specification.

In the present disclosure, it will be understood that each block of the flowchart illustrations and combinations of flowchart illustrations can be performed by computer program instructions.

Since these computer program instructions can be mounted on a processor of a general purpose computer, special purpose computer, or other programmable data processing equipment, those instructions executed through the computer or the processor of other programmable data processing equipment can create a means to perform the functions be described in flowchart block(s).

These computer program instructions can be stored in a computer usable or computer readable memory that can be directed to a computer or other programmable data processing equipment to implement functionality in a particular manner, and thus the computer usable or computer readable memory. It is also possible for the instructions stored in to produce an article of manufacture containing instruction means for performing the functions described in the flowchart block(s).

Computer program instructions can also be mounted on a computer or other programmable data processing equipment, such that a series of operating steps can be performed on the computer or other programmable data processing equipment to create a computer-implemented process to create a computer or other programmable data. Instructions for performing the processing equipment can also provide steps for performing the functions described in the flowchart block(s).

In addition, each block can represent a portion of a module, segment, or code that includes one or more executable instructions for executing a specified logical function(s). It should also be noted that in some alternative implementations, the functions noted in the blocks can occur out of order. For example, the two blocks shown in succession can in fact be executed substantially concurrently, or the blocks can sometimes be executed in the reverse order, depending on the corresponding function.

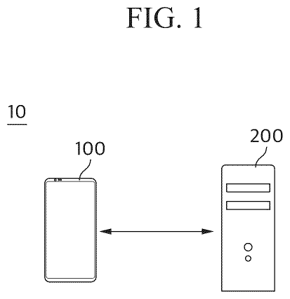

FIG. 1 is a diagram illustrating an example of a system 10. In some implementations, the system 10 can be related to an e-commerce service. For example, the e-commerce service can be an online store service that mediates sellers and buyers online to buy and sell products. In some implementations, the system 10 can include a terminal 100 and a server 200.

In some implementations, the terminal 100 of a user can be a device of a purchaser who purchases an item. The user can access the server 200 through an application of the terminal 100 of the user, search for a desired item, and place an order.

In some implementations, the server 200 can include at least one server for operating an e-commerce service. The server 200 can include a front-end server that provides a graphical user interface (GUI) environment to the terminal 100 of the user. The server 200 can provide a web page or application to the terminal 100 of the user. The server 200 can operate an application or a web page related to an online store service. The server 200 can manage various programs (e.g., software) for operating the online store service. The server 200 can send and receive a variety of information to and from the terminal 100 of the user. The server 200 can acquire a variety of information associated with the application from the terminal 100 of the user and provide the acquired information to another device.

In some implementations, the terminal 100 can receive an item selection input from a user to select a specific item. The terminal 100 can communicate with the server 200 based on the item selection input, and the server 200 can transmit information related to a corresponding item and a user interface for a payment process (e.g., a user interface for providing an item purchase checkout) to the terminal 100. The terminal 100 can prompt the user to complete payment through the user interface received from the server 200.

Operations described herein can be performed by the terminal 100, and it is merely an example. Some operations can be performed by the server 200.

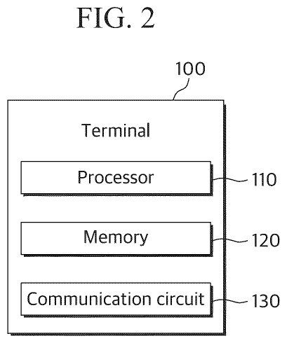

FIG. 2 is a diagram illustrating an example of the terminal 100. In some implementations, the terminal 100 can include a processor 110, a memory 120, and a communication circuit 130. At least one of elements included in the terminal 100 can be omitted, or other components can be added to the terminal 100. Additionally or alternatively, some elements can be implemented in an integrated manner or implemented as singular or multiple entities. At least a portion of elements in the terminal 100 can be implemented as integrated entities or as singular or multiple entities. At least a portion of elements in the terminal 100 can be interconnected via a bus, a general purpose input/output (GPIO), a serial peripheral interface (SPI), or a mobile industry processor interface (MIPI), to exchange data and/or signals.

In some implementations, the processor 110 is a configuration that performs data processing or computational operation related to control and/or communication of elements of the terminal 100, and can be operatively connected to elements of the terminal 100. The processor 110 can load instructions or data received from other elements of the terminal 100 into the memory 120, process the instructions or data stored in the memory 120, and store result data. Unless otherwise stated, in the present disclosure, the processor 110 can indicate a group of one or more processors 110.

In some implementations, the memory 120 can store various data used by at least one element (e.g., the processor 110). The memory 120 can store instructions for an operation of the processor 110 described above. The program can be stored as software in the memory 120 and can include, for example, an operating system, middleware, or an application. Unless otherwise stated, in the present disclosure, the memory 120 can indicate a group of one or more memories 120.

In some implementations, the communication circuit 130 can establish a wired or wireless communication channel along with an external device (e.g., the server 200) and can transmit and receive various data to and from the external device. The communication circuit 130 can include at least one port for connecting to an external device via a wired cable to enable wired communication with the external device. The communication circuit 130 can be configured to connect to a cellular network (e.g., 3G, LTE, 5G, Wibro, or Wimax) including a cellular communication module. In some implementations, the communication circuit 130 can include a short-range communication module to transmit and receive data to and from an external device using short-range communication (e.g., Wi-Fi, Bluetooth, Bluetooth low energy (BLE), and UWB), but is not limited thereto.

In some implementations, the terminal 100 can further include a display. The display can visually provide a variety of information to an outside under a control of the processor 110. The display can include touch circuitry configured to sense a user's touch or sensor circuitry configured to measure a magnitude of force generated by a touch.

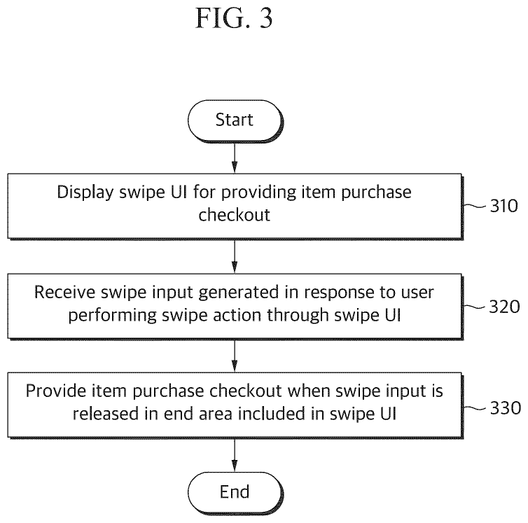

FIG. 3 is a flowchart illustrating an example operation of the terminal 100.

Referring to FIG. 3, in operation 310, the terminal 100 can display a swipe user interface (UI) for providing item purchase checkout. In some implementations, the terminal 100 can induce a user to complete a one-click purchase of an item by displaying information associated with the item and a swipe UI for a one-click purchase process based on an item selection input.

In some implementations, the swipe UI can be provided in a form of a swipe bar and include a swipe handle so that the user operates intuitively. The swipe handle can be implemented in a form of a button to be dragged and moved in a first direction (e.g., horizontally) in response to a user's input action (e.g., a click or a touch).

In some implementations, the terminal 100 can receive an item selection input from a user to select a specific item. For example, the item selection input can be received when a user selects a one-click purchase button on an item details page corresponding to the item or on an item list page (e.g., shopping cart page) containing the item. The one-click purchase button can include text supporting one-click purchase of the item (e.g., “Buy Now”).

In some implementations, the item selection input can include a selection action from a list of items (e.g., shopping cart, recommended items list, etc.) in addition to direct selection of a single item. In this case, the terminal 100 can automatically receive an identifier of the item and related payment information from the server 200 and determine whether to display the swipe UI.

In some implementations, the terminal 100 can display the swipe UI when a purchase condition related to the item selected by the item selection input is satisfied. As an example, the terminal 100 can display the swipe UI if a payment amount for the item is less than or equal to a preset reference amount (e.g., 50,000 won). As another example, when a plurality of items is selected by the item selection input, the terminal 100 can display the swipe UI if a total payment amount of the plurality of items is less than or equal to the preset reference amount. Also, the display conditions of the swipe UI can be adjusted according to user settings of the terminal 100 or an application's policy. For example, when the user enables a “show easy checkout first” option, the swipe UI can be displayed even if the reference amount is exceeded.

In operation 320, the terminal 100 can receive a swipe input generated in response to the user performing a swipe action through the swipe UI displayed in operation 310. In some implementations, the terminal 100 can track consecutive input events on the swipe UI in real time, including a point at which a user's input action (e.g., click or touch) is performed, a swipe path, and a swipe distance. For example, the terminal 100 can visually update a current swipe progress status while the user performs the swipe action. In some implementations, the swipe progress status can be presented in a variety of ways, for example, a progress bar, a color gradient change, and a text guidance on remaining distance. Through this, the user can intuitively recognize how close a current action is to completing payment.

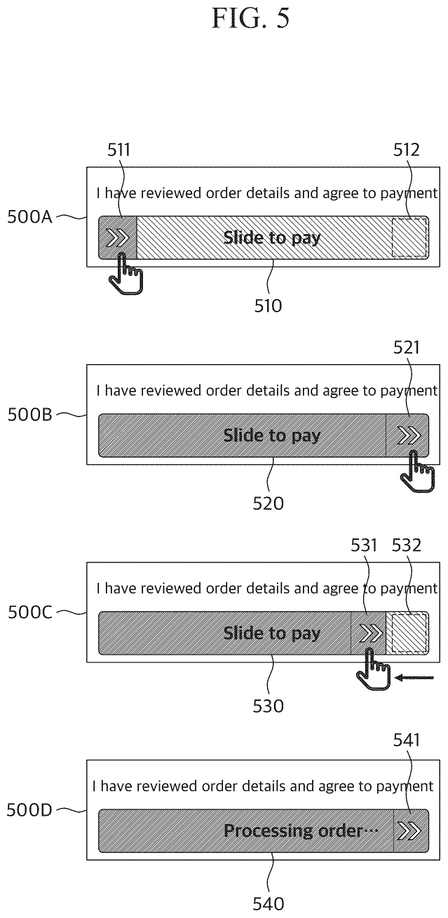

In operation 330, the terminal 100 can provide the item purchase checkout when the swipe input received in operation 320 is released in an end area included in the swipe UI. The end area refers to a predetermined range or area that is set in the swipe UI, and will be explained with reference to FIGS. 5 through 7. In some implementations, the terminal 100 can perform a payment process (e.g., calling a payment module, displaying a payment completion screen) in response to the swipe input being released in the end area included in the swipe UI.

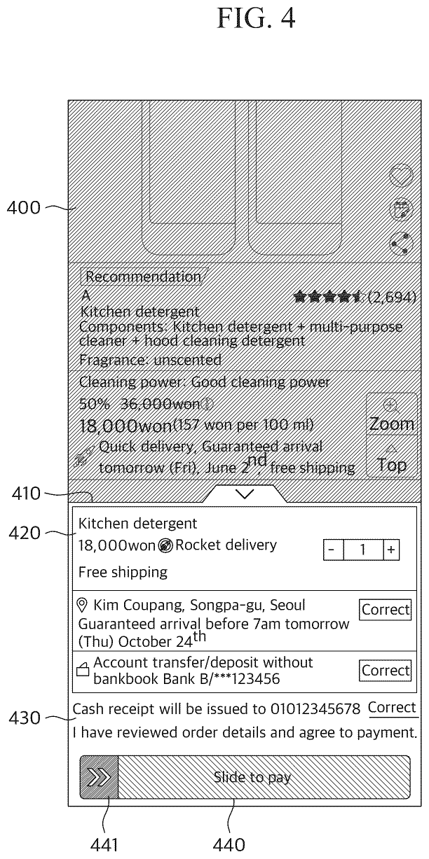

Hereinafter, with reference to FIGS. 4 through 7, the operations of FIG. 3 will be explained in detail through UIs corresponding to the operations.

FIG. 4 is a diagram illustrating an example of an item purchase UI 410 arranged to be overlaid on an item details page 400. Specifically, FIG. 4 illustrates an example of the item purchase UI 410 displayed on the terminal 100 based on an item selection input received in response to a user selecting a one-click purchase button included in the item details page 400.

Referring to FIG. 4, the item purchase UI 410 can be arranged to be overlaid on the item details page 400. The item purchase UI 410 can include an item information area 420 and a purchase checkout area 430. The terminal 100 can support a user to quickly complete payment for a selected item without going through a complicated process by integrating the item information area 420 and the purchase checkout area 430 into a single UI (e.g., the item purchase UI 410) and displaying the single UI on a single screen. In addition, the item purchase UI 410 can display payment options (e.g., a shipping option, a payment method, etc.).

In some implementations, the item purchase UI 410 can be positioned to be fixed at a designated location on the screen (e.g., at the bottom), and a shadow effect or a translucent background can be applied so that a content area corresponding to the item details page 400 is visually clearly distinguished from the item purchase UI 410. Through this, the user can continuously see and access a payment interface even while scrolling.

In some implementations, the terminal 100 can determine whether to display the item purchase UI 410 based on size information or resolution information of a display. For example, the terminal 100 can display the item purchase UI 410 on the screen when a size or resolution of the display is greater than or equal to a predetermined threshold, and may not display the item purchase UI 410 when the size or resolution of the display is less than the predetermined threshold. In this example, the terminal 100 can provide a dedicated payment page or pop-up based on an item selection input so that a payment flow is not interrupted for the user's selected item even when the size or resolution of the display is less than the predetermined threshold. In addition, a layout of the item purchase UI 410 can be applied differently based on an orientation of the display (e.g., a portrait mode or a landscape mode). For example, as shown in FIG. 4, in the portrait mode, the item information area 420 and the purchase checkout area 430 can be displayed in a vertical arrangement. In the landscape mode, the item information area 420 and the purchase checkout area 430 can be split left and right to be rearranged.

In some implementations, the terminal 100 can adjust a size or a layout of a swipe UI 440 or the purchase checkout area 430 included in the item purchase UI 410 based on the size information or the resolution information of the display. For example, the terminal 100 can maintain a readability and usability of a user interface by reducing a height of a swipe bar and a size of a handle on a relatively small screen and applying a responsive layout that fits a horizontal space of the screen. In some implementations, the swipe UI 440 can have a minimum threshold size and a maximum threshold size so as to be changed in size flexibly in a range therebetween based on the resolution of the display.

In some implementations, the item information area 420 can display minimum information (e.g., name, price, discount information, etc.) of an item selected by the user. Accordingly, the user can check characteristics of the item before purchasing.

In some implementations, the purchase checkout area 430 can include the swipe UI 440 for a one-click purchase checkout. As shown in FIG. 4, the swipe UI 440 can be provided in a form of a swipe bar including a swipe handle 441.

In some implementations, the swipe handle 441 can be positioned to be in contact with a start portion (e.g., a left end portion) in a first direction (e.g., a horizontal direction) in the swipe UI 440. The user can perform a swipe action by dragging the swipe handle 441. In response to the user performing a drag action and a release action through the swipe handle 441, a swipe input can be generated.

In some implementations, the terminal 100 can provide a visual feedback or a tactile feedback based on the swipe input. As an example, the terminal 100 can provide the visual feedback or the tactile feedback when at least a portion of the swipe handle 441 reaches an end area of the swipe UI 440 during the swipe action. As another example, the terminal 100 can provide the visual feedback or the tactile feedback when the swipe action is released while at least a portion of the swipe handle 441 is positioned in the end area of the swipe UI 440.

In some implementations, the terminal 100 can change a color of the swipe UI 440 based on a progress status of the swipe action as the visual feedback. As an example, the terminal 100 can provide the visual feedback by changing a color of the swipe handle 441. As another example, the terminal 100 can provide the visual feedback by changing an overall color of the swipe UI 440 or applying a visual effect that emphasizes a border of the swipe UI 440.

In some implementations, the terminal 100 can generate micro-vibrations (e.g., a haptic feedback) as the tactile feedback. As an example, the terminal 100 can generate the micro-vibration immediately when at least a portion of the swipe handle 441 reaches the end area of the swipe UI 440 during the swipe action so that the user can recognize that a payment is imminent. As another example, the terminal 100 can generate the micro-vibration to indicate that the swipe action is complete when at least a portion of the swipe handle 441 is released while positioned in the end area of the swipe UI 440.

FIG. 5 is a diagram illustrating examples of purchase checkout areas 500A, 500B, 500C, and 500D. Specifically, FIG. 5 illustrates, in a stepwise manner, an example in which a user performs a swipe action by dragging swipe handles 511, 521, 531, and 541, and accordingly, swipe bars 510, 520, 530, and 540 are changed.

The purchase checkout area 500A represents an example in which the swipe action is initiated by a user performing an input action on the swipe handle 511 positioned to be in contact with a start portion (e.g., a left end portion) in a first direction (e.g., horizontal direction) in the swipe bar 510. In some implementations, the swipe bar 510 can include an end area 512 of a predetermined size, starting from an end portion in the first direction (e.g., a right end portion). However, it is merely an example, and the end area 512 can include only the end portion of the swipe bar 510 in the first direction. In some implementations, when the swipe input is released at the end area 512, the payment process can proceed. For example, the terminal 100 can provide an item purchase checkout when at least a portion of the swipe handle 511 is released during the swipe action while positioned in the end area 512.

In some implementations, the swipe bar 510 can include a UI element that allows the end area 512 to be distinguished from a remaining area of the swipe bar 510 aside from the end area 512. For example, the UI element can include at least one of a border emphasis, a translucent overlay, and a highlight corresponding to the end area 512.

In some implementations, the terminal 100 can provide a visual feedback or a tactile feedback when the swipe handle 511 reaches the end area 512 during the swipe action. For example, the terminal 100 can provide the visual feedback or the tactile feedback when at least a portion of the swipe handle 511 reaches the end area 512 during the swipe action.

In some implementations, the terminal 100 can provide the visual feedback or the tactile feedback when the swipe input is released in the end area 512. For example, the terminal 100 can provide the visual feedback or the tactile feedback when at least a portion of the swipe handle 511 is released during the swipe action while positioned in the end area 512.

The purchase checkout area 500B represents an example in which the user drags the swipe handle 521 of the swipe bar 520 to the right end and does not release the swipe handle 521. In this example, since the user does not release the swipe handle 521, the terminal 100 may not provide a payment process.

In some implementations, as represented in the purchase checkout area 500B, the terminal 100 can update and display a filled-in progress status (e.g., a bar, a color change, etc.) of the swipe bar 520 in real time in accordance with the swipe handle 521 moving.

The purchase checkout area 500C represents an example in which the user drags a portion of the swipe handle 531 of the swipe bar 530 back in a left direction. The user can move the swipe handle 531 to the left end, and then drag a portion of the swipe handle 531 back instead of releasing the swipe handle 531, which can allow the user to review a payment action or cancel a swipe made accidentally. In some implementations, the terminal 100 can provide the visual feedback or the tactile feedback immediately when the swipe handle 531 leaves an end area 532, thereby allowing the user to recognize a deviation from a payment completion area.

The purchase checkout area 500D represents an example in which the terminal 100 proceeds with a payment process in response to the user releasing the swipe handle 541 of the swipe bar 540 in an end area (e.g., the end area 512 or 532). In some implementations, when a predetermined size of area, starting from the right end of the swipe bar 540 is set to be the end area (e.g., the end area 512 or 532), and when the swipe input is released in the end area, the terminal 100 can proceed with the payment process (e.g., calling a payment module and displaying a payment completion screen) immediately.

In some implementations, the terminal 100 can visually indicate that the payment process is in progress by changing the color of the swipe bar 540 or displaying designated text (e.g., “processing order . . . ”) on the swipe bar 540. In some implementations, the terminal 100 can also provide the tactile feedback immediately when the swipe input is released in the end area.

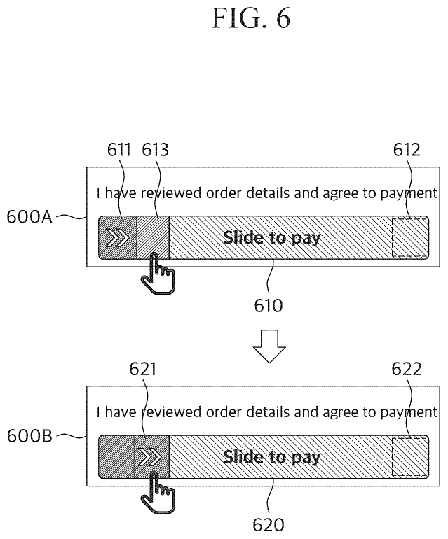

FIG. 6 is a diagram illustrating examples of purchase checkout areas 600A and 600B. Specifically, FIG. 6 illustrates, in a stepwise manner, an example in which a swipe action is initiated by a user performing an input action on an extended area 613 included in a target area.

As represented in the purchase checkout area 600A, a swipe bar 610 can include a target area including the extended area 613 in addition to a handle area corresponding to a swipe handle 611. The target area can refer to an area in which the swipe action is initiated by the user performing the input action. For example, the swipe action can be initiated when the user performs the input action on the handle area corresponding to a swipe handle 611. Also, the swipe action can be initiated when the user performs the input action on the extended area 613 located to the right of the swipe handle 611. In some implementations, a size of the extended area 613 can be set to be identical to an end area (e.g., an end area 612 or an end area 622).

In some implementations, the extended area 613 can be displayed so as to be visually indistinguishable from a remaining area of the swipe bar 610 aside from the swipe handle 611 and the extended area 613. For example, the extended area 613 can be displayed in the same color as the remaining area. However, it is merely an example, and the extended area 613 can be displayed differently so as to be distinguished from the remaining area of the swipe bar 610.

The purchase checkout area 600B represents an example in which the user starts the swipe action by performing the input action on the extended area 613. In this example, the terminal 100 can recognize a point at which the user performs the input action as a new starting point of the swipe action. Accordingly, the terminal 100 can move a swipe handle 621 to the point at which the user performs the input action. After that, the user can perform the swipe action by dragging the swipe handle 621. When the user releases the swipe handle 621 in the end area 622, the terminal 100 can proceed with the payment process.

As such, by setting the target area that includes the extended area 613, the user can conveniently start the swipe action without making precise contact with the swipe handle 611, which may not only improve usability, but also support a smooth input action by allowing an area of the swipe handle 611 to be set in a reduced size.

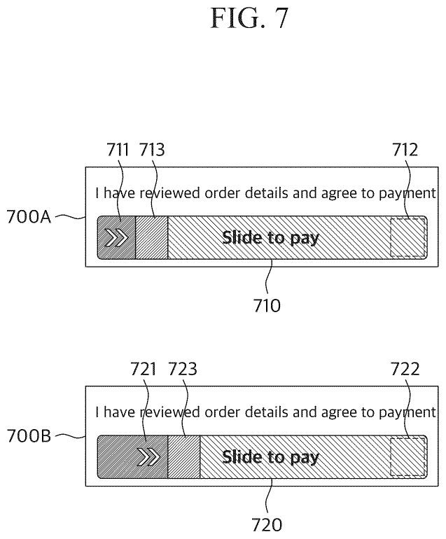

FIG. 7 is a diagram illustrating examples of purchase checkout areas 700A and 700B. Specifically, FIG. 7 illustrates examples in which swipe handles 711 and 721 included in swipe bars 710 and 720 are set in different sizes.

As represented in the purchase checkout area 700A, the swipe bar 710 can include the swipe handle 711 and an end area 712. In addition, the swipe bar 710 can include an extended area 713 allowing the user to start the swipe action by performing an input action.

As represented in the purchase checkout area 700B, the swipe bar 720 can include the swipe handle 721 having a size greater than a size of the swipe handle 711 of the purchase checkout area 700A. For example, the size of the swipe handle 721 can be set to 20% of an entire area of the swipe bar 720, but is not limited thereto. Even in this example, the swipe bar 720 can include an end area 722, and even though the size of the swipe handle 721 is set to be greater than the size of the swipe handle 711 of the purchase checkout area 700A, can include an extended area 723 so as to support a user to start the swipe action in a wider area. In addition, even if an area of the swipe handle 721 is expanded, the end area 722 and the expanded area 723 can be set according to an existing policy (e.g., a predetermined ratio of the total area of the swipe bar), so that both user convenience and intuitiveness are satisfied.

The present specification and drawings have been described with respect to the example implementations of the present disclosure. Although specific terms are used, it is only used in a general sense to easily explain the technical content of the present disclosure and to help the understanding of this disclosure, and is not intended to limit the scope of the specification. It will be apparent to those skilled in the art that other modifications based on the technical spirit of the present disclosure can be implemented in addition to the example implementations described herein.

The electronic device or terminal in accordance with the above-described example implementations can include a processor, a memory which stores and executes program data, a permanent storage such as a disk drive, a communication port for communication with an external device, and a user interface device such as a touch panel, a key, and a button. Methods realized by software modules or algorithms can be stored in a computer-readable recording medium as computer-readable codes or program commands which can be executed by the processor. Here, the computer-readable recording medium can be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium can be dispersed to computer systems connected by a network so that computer-readable codes can be stored and executed in a dispersion manner. The medium can be read by a computer, can be stored in a memory, and can be executed by the processor.

The present example implementations can be represented by functional blocks and various processing steps. These functional blocks can be implemented by various numbers of hardware and/or software configurations that execute specific functions. For example, the present example implementations can adopt direct circuit configurations such as a memory, a processor, a logic circuit, and a look-up table that can execute various functions by control of one or more microprocessors or other control devices. Similarly to that elements can be executed by software programming or software elements, the present example implementations can be implemented by programming or scripting languages such as C, C++, Java, and assembler including various algorithms implemented by combinations of data structures, processes, routines, or of other programming configurations. Functional aspects can be implemented by algorithms executed by one or more processors. In addition, the present example implementations can adopt the related art for electronic environment setting, signal processing, and/or data processing, for example. The terms “mechanism”, “element”, “means”, and “configuration” can be widely used and are not limited to mechanical and physical components. These terms can include meaning of a series of routines of software in association with a processor, for example.

The above-described example implementations are merely examples and other implementations can be implemented within the scope of the following claims.

1. A method for controlling a user interface (UI) of a terminal, the method comprising:
displaying a swipe UI for providing a checkout of an item purchase, wherein displaying the swipe UI comprises displaying a swipe bar including a swipe handle;
receiving a swipe input that is generated in response to a user performing a swipe action through the swipe UI, wherein receiving the swipe input comprises detecting a start of the swipe action based on the user performing an input action on a target area of the swipe UI, the target area including a handle area corresponding to the swipe handle and an extended area included in the swipe bar;
upon detecting an initial touch input on the extended area, moving the swipe handle to a point at which the initial touch input is detected within the extended area to establish a new starting point for the swipe action, wherein the swipe input is generated in response to the user performing a drag action and a release action through the moved swipe handle along the swipe bar; and
providing the checkout of the item purchase based on the swipe input being released from a predetermined area of the swipe UI.

2-4. (canceled)

5. The method of claim 1, wherein displaying the swipe UI comprises:
displaying the extended area that is not visually distinguished from a remaining area of the swipe bar other than the extended area and the handle area.

6. The method of claim 1, wherein a size of the extended area is identical to a size of the predetermined area of the swipe UI.

7. The method of claim 1, wherein a size of the swipe handle is 20% of a total size of the swipe bar.

8. The method of claim 1, further comprising:
providing a visual feedback or a tactile feedback based on the swipe input being generated through the swipe handle.

9. The method of claim 1, further comprising:
providing a visual feedback or a tactile feedback based on at least a portion of the swipe handle reaching the predetermined area during the swipe action.

10. The method of claim 1, further comprising:
providing a visual feedback or a tactile feedback based on at least a portion of the swipe handle being released in a state in which at least the portion of the swipe handle is located in the predetermined area during the swipe action.

11. The method of claim 8, wherein providing the visual feedback comprises changing a color of the swipe handle.

12. The method of claim 1, wherein displaying the swipe UI comprises displaying the swipe handle at a first end portion of the swipe bar in a first direction, and
wherein the predetermined area is defined at a second end portion of the swipe bar in the first direction.

13. The method of claim 12, wherein the predetermined area has a predetermined size and corresponds to an area starting from an edge of the second end portion of the swipe bar.

14. The method of claim 1, wherein providing the checkout of the item purchase comprises:
providing the checkout based on at least a portion of the swipe handle being released in a state in which at least the portion of the swipe handle is located in the predetermined area during the swipe action.

15. The method of claim 1, wherein the swipe UI includes a UI element configured to distinguish the predetermined area from a remaining area other than the predetermined area of the swipe UI.

16. The method of claim 15, wherein the UI element includes at least one of a border emphasis, a translucent overlay, or a highlight, corresponding to the predetermined area.

17. A non-transitory computer-readable recording medium including a computer program configured to perform the method of claim 1.

18. A terminal comprising:
a processor; and
a memory storing at least on instruction that, based on being executed by the processor, perform operations comprising:
displaying a swipe user interface (UI) for providing a checkout of an item purchase, wherein displaying the swipe UI comprises displaying a swipe bar including a swipe handle,
receiving a swipe input that is generated in response to a user performing a swipe action through the swipe UI, wherein receiving the swipe input comprises detecting a start of the swipe action based on the user performing an input action on a target area of the swipe UI, the target area including a handle area corresponding to the swipe handle and an extended area included in the swipe bar,
upon detecting an initial touch input on the extended area, moving the swipe handle to a point at which the initial touch input is detected within the extended area to establish a new starting point for the swipe action, wherein the swipe input is generated in response to the user performing a drag action and a release action through the moved swipe handle along the swipe bar; and
providing the checkout of the item purchase based on the swipe input being released from a predetermined area of the swipe UI.

19. (canceled)

20. The terminal of claim 18, wherein displaying the swipe UI comprises displaying the swipe handle at a first end portion of the swipe bar in a first direction, and
wherein the predetermined area is defined at a second end portion of the swipe bar in the first direction.
